(19) United States
(12) Patent Application Publication
(10) Pub. No.: US 2009/0155749 A1
(43) Pub. Date: Jun. 18, 2009

(54) Electronic globe and game system used therewith

(76) Inventor: Mary Ann Cogliano, Santa Rosa, CA (US)

Correspondence Address: Mitchell B. Wasson, Esq.;Hoffman, Wasson & Gitler, P.C., Suite 522, 2461 South Clark Street, Arlington, VA, 22202, US

(21) Appl. No.: 12/000,699

(22) Filed: Dec. 17, 2007

(51) Int. Cl. G09B 27/08

(52) U.S. Cl. 434/145

(57) ABSTRACT

A teaching device including a globe and a DVD player. A wireless connection is provided between the globe and the DVD player. Based upon an individual's choosing a location on the globe or based upon a video clip played on the monitor of the DVD, information relating to that particular spot on the globe would be displayed.

### FIELD OF THE INVENTION

The present invention is directed to a system utilizing an electronic globe wirelessly connected to a DVD game or teaching instrument.

### BACKGROUND OF THE INVENTION

It is axiomatic that the last several years the world in which we live has seemingly grown smaller. At the turn of the 20th century, knowledge of the world outside of your community, state or country was quite limited and often unnecessary. Children and other individuals were taught geography using rudimentary globes as well as maps provided in atlases which were in many instances outdated. Since travel between North America and Europe, Asia and Australia was quite limited, many individuals thought it unnecessary to learn geography, world history as well as foreign languages since interaction with foreign cultures was almost nonexistent.

However, the dawning of the 21st century has changed many individual's outlook on the world in which we live. Communications as well as travel between the United States and foreign countries resulting in an interaction between ourselves and foreign cultures mandate that we have an understanding of not only the geography of these countries but also an understanding of the cultures that they represent which would lead to a better understanding between people.

As previously indicated, geography was initially taught by the study of maps and a three dimensional globe. However, the development of various teaching implements and devices such as the computer and CD ROMS or DVDs, has changed the manner in which teaching is accomplished. The use of these new technologies would not only allow children and other individuals the access to various facts, the manner in which they are displayed as well as the interaction between students and these educational tools would also allow the student's interest in geography to be maintained.

The prior art patent literature is replete with references showing various manners of representing a globe. For example, U.S. Pat. No. 6,527,555, issued to Storm describes a globe associated with a programmable/re-programmable display. The globe contains an interior cube having a plurality of flat panel displays which, with the assistance of optical lens segments, would project each screen onto the interior surface of a sphere. An external programming device would be used in conjunction with a microprocessor to change the output of the flat panel display. It is noted that the display can include various features, such as the movement of tectonic plates, weather patterns or glacial movements. Although there is no doubt that this type of globe can be used as a teaching device, there is no suggestion of the use of a separate interactive display screen.

U.S. Pat. No. 5,931,677 illustrates an educational globe tool provided with a plurality of bores included on a rigid blank translucent sphere. Various geographical features such as translucent country pieces would be inserted into one of the bores. Additionally, a switch is associated with each of the bores. Therefore, utilizing the electrical control illustrated in FIG. 6, a lamp associated with a particular bore would be illuminated. Similar to the patent to Storm, there is a limited interaction between an individual and the globe.

U.S. Pat. No. 5,519,809, issued to Husseiny et al describes a system and method for displaying geographical information using a combination of a globe, a monitor, a keyboard and a microprocessor to display information relating to a particular portion of the globe which may be illuminated. Although this patent does include an interaction between various features on the globe and a monitor, it would be relatively difficult for children to use.

U.S. Pat. Nos. 6,773,262 and 6,860,739, both issued to Blum describe a globe in communication with a display. Based upon the position of the globe, the display would illustrate detailed information relating to that particular position on the globe. However, the main thrust of these patents is to provide maps associated with that particular position and not used as an educational teaching device.

Consequently, there still remains a need for an improved educational tool to teach geography as well as information relating to a particular geographical location, such as a foreign language, the history of the geographical location among other fields of study, yet keeping the interest of the students.

### SUMMARY OF THE INVENTION

The deficiencies of the prior art are addressed by the present invention which includes a globe in communication with a CD ROM or DVD allowing various features to be projected upon a monitor as well as including the appropriate verbal output related to the images projected on the monitor. The globe would be provided with a device for communicating information to the DVD or similar device, preferably utilizing a wireless connection between the globe and the DVD or similar device. A steering wheel or joystick is associated with the globe. In one embodiment, the movement of the wheel or joystick would control the movement of a particular icon on the monitor, such as a helicopter, hot air balloon, plane or similar vehicle for traversing a geographical portion of the world.

A second embodiment would utilize a steering wheel or joystick to move the aforementioned object or objects over the surface of the globe. In both embodiments, once a portion of the world globe is chosen for educational purposes, various photographs or video scenes would be projected onto the monitor. Verbal information would also be provided teaching the individual student about various features of that particular portion of the globe, such as the actual geography of the portion of the globe illustrated on the monitor as well as information relating to the language spoken in that portion of the globe as well as the climate as well as other types of information including various trivia and facts relating to that portion of the globe illustrated on the monitor.

### BRIEF DESCRIPTION OF THE DRAWINGS

The foregoing and other objects of this invention, the various features thereof, as well as the invention itself, will be more fully understood from the following description, when read together with the accompanying drawings in which:

FIG. 1 is a perspective view of a first embodiment of the present invention;

FIG. 2 is a perspective view of the globe used in the first embodiment of the present invention;

FIG. 3 is a perspective view of a second embodiment of the present invention;

FIG. 4 is a perspective view of the globe used in the second embodiment of the present invention; and

FIG. 5 is a circuit and block diagram of controls of the present invention.

### DETAILED DESCRIPTION OF THE DRAWINGS

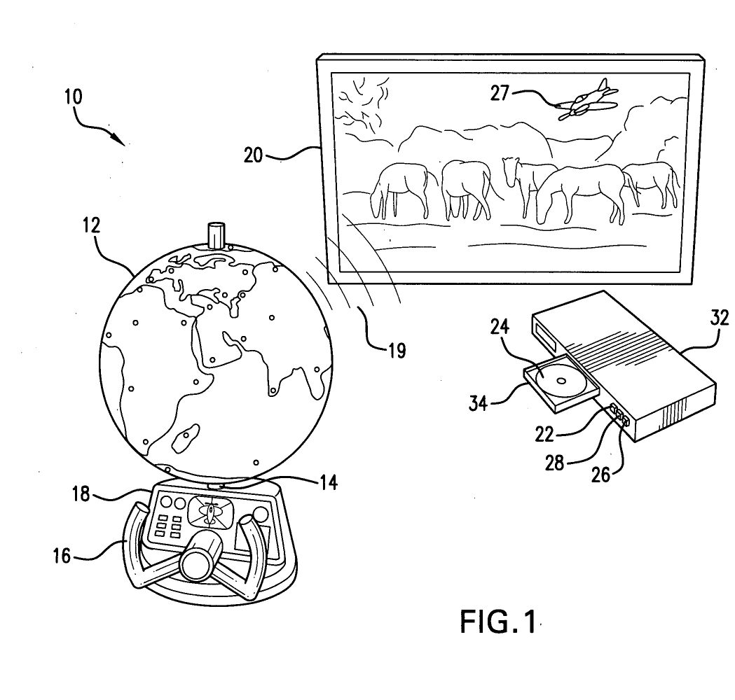

FIG. 1 illustrates a first embodiment of the present invention 10 allowing a child or any other individual to interactively learn information relating to geography and related topics. The system includes a globe 12 provided with the usual topographical features, such as continents, countries, and oceans applied to the top surface thereof. A support 14 including a base is physically connected to the bottom surface of the globe. A console 18 provided with a wheel or joystick 16 is attached to the support 14, or provided a short distance from the support 14. The console is provided with a plurality of control buttons for controlling the operation of the teaching device. The joystick or wheel 16, the control buttons, or switches as well as additional information relating to a particular feature on the globe would be wirelessly communicated between the globe, console and a DVD player 32 or similar device. The DVD player 32 is associated with a television or other monitor 20 and also includes movable support device 34 on which a standard DVD cartridge 24 would be provided. The cartridge would include various information projected on the monitor 20. The globe 12 would be provided with a device for transmitting a wireless signal 19 to a receiver 22 associated with the DVD 32. Alternatively, wireless information could be sent directly from the console to the receiver 22 of the DVD player 32. The DVD 32 would also include an on/off device 26, a speaker 28 for producing audio information as well as other input/output devices necessary to operate the present invention. It is also noted that the speaker 28 could be provided on the monitor 20.

In operation, various portions of the globe stored on the cartridge 24 would be projected upon the monitor 20. The joystick or wheel 16 would control the operation of an icon 27, such as an airplane, helicopter, hot air balloon or other device capable of traversing the globe. The joystick or wheel 16 would be provided with a device for wirelessly transmitting its movement to the DVD allowing the traversing icon 27 to move over the globe. The control buttons on the console would allow an individual to choose the particular icon 27 which is projected onto the monitor 20. For example, if the individual chose a helicopter as the icon 27, the helicopter's propeller would spin when moving across the scene depicted on the monitor 20. Similarly, if the icon 27 is a propeller plane, its propeller would also spin. The individual controlling the movement of the joystick or wheel 16, using one or more control buttons associated with the steering device would choose a destination on which to land the traversing icon 27. At this point, a wireless signal would be transmitted from the DVD 32 to one of a plurality of light emitting diodes (LEDs) or other illumination devices 40, thereby illuminating that portion of the globe on which the traversing icon has landed. At this point additional information would be projected onto the monitor screen 20. Various buttons on the console 18 would be used to answer various questions posed by the information on the monitor or provided by accompanying audio material. Additionally, the control buttons could be used to move to various locations on the cartridge 24.

Operating in one mode, players would be mesmerized as they control the movement of icon 27 as they see a bird's-eye view of the world on the monitor 20, a perspective of the globe which is not readily available to the average person.

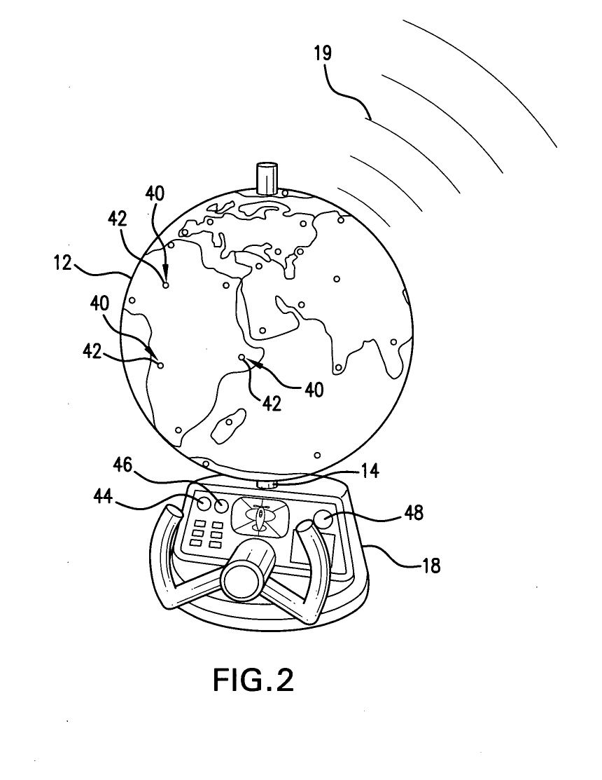

Alternatively, as shown in FIG. 2, a plurality of switches 42 are associated with each of the illumination devices 40, such as light emitting diodes (LEDs). These switches are generally pressure activated and, as the individual is controlling the movement of the traversing icon 27 utilizing the joystick or wheel 16, the individual would depress the particular switch associated with a geographical location on the globe at the point the icon has landed. As will be further explained, the depression of a particular switch would be transmitted to particular electronics included within the globe 12 or the support 14 or control console associated with the joystick or wheel 16 which in turn would be wirelessly transmitted from the transmitting device associated with the globe 12 or transmission device to the DVD player 32.

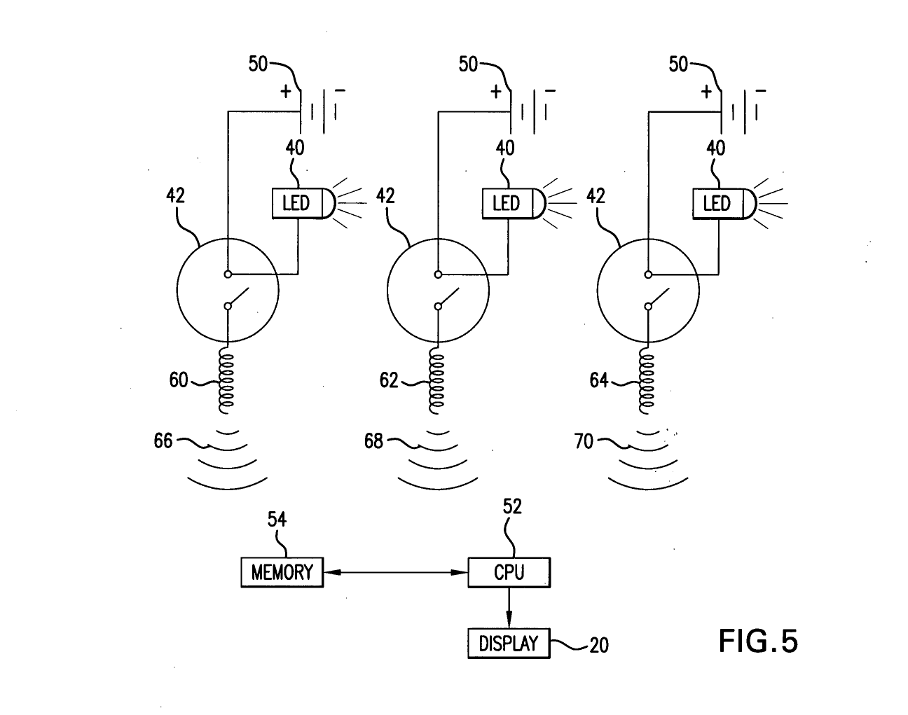

As shown in FIG. 5, the DVD player 54 in conjunction with the disk 24 would have memory used to display various features on the monitor 20. A CPU or other microprocessor 52 would control the operation of the DVD device. Consequently, based upon the particular destination designated by the individual either by the joystick or wheel 16 or the depression of one of the switches 42, as shown in FIG. 5, an appropriate still photograph or video clip would be shown on the display 20. Simultaneously, the appropriate light emitting diode 40 or other device would be illuminated on the globe.

The present invention would allow interaction with the individuals controlling the present system and teach them how to observe various situations and solve problems as they explore the world. Along the way, the individuals would learn basic foreign language words and phrases as well as other facts and trivia.

FIG. 2 illustrates the globe 12 provided with the plurality of LEDs 40 and switches 42 associated therewith. Various switches or control buttons are associated with the joystick or wheel 16 to assist in the operation of this educational globe. These switches could control but are not limited to an on/off switch 44 as well as a mode switch 46 used to determine which of a series of embodiments the system would operate. A send switch 48 would be depressed to indicate which portion of the world depicted on monitor 20 the traversing icon would alight. These, or other switches not shown would be used to control various modes of operation.

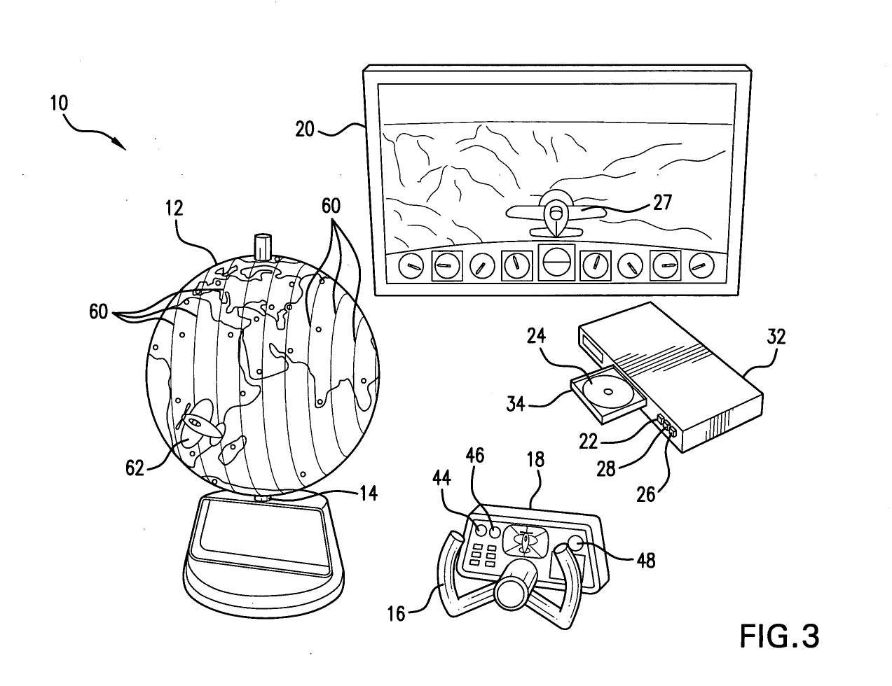

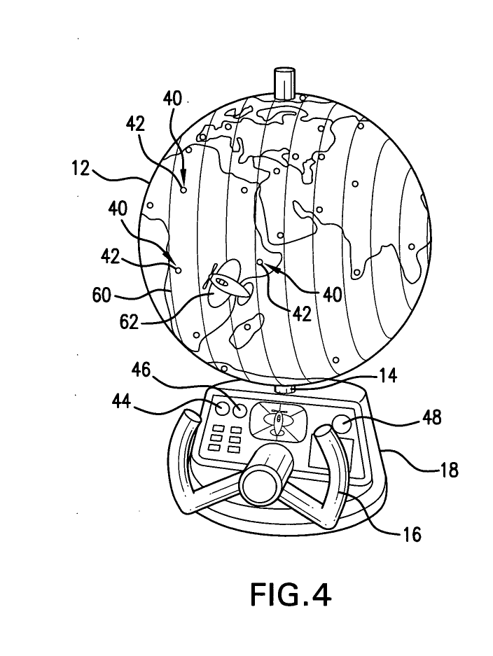

A second embodiment of this invention is shown with respect to FIGS. 3 and 4. In this embodiment, the electronic globe 12 is provided with various topographical features similar to the globe shown in FIG. 1. However, this globe is also provided with a series of tracks 60 which extend along the surface of the globe 12. A device, such as a plane or helicopter 62 would move along the track based upon the operation of the joystick or wheel 16. The steering mechanism to control the movement of the plane or helicopter 62 would be provided between the joystick or wheel 16, through the support 14 and into the interior of the globe. The device 62 would include a propeller which would spin as the device 62 moves over the surface of the globe. A sensing device, also provided in the interior of the globe would specifically indicate the location of the plane or helicopter. A wireless connection is provided between a transmitter/receiver included on the surface of the globe 12 and the transmitter/receiver 22 associated with the DVD player 32.

In this second embodiment, the player would move the plane or helicopter 62 along the track 60 through the use of the joystick or wheel 16. Once the individual moves the plane or helicopter to a specific location along the track 60, one of the control buttons such as the send button 48 would be engaged. The sensing and steering mechanism within the globe 12 would locate the specific spot the plane or helicopter stops and would wirelessly transmit this information from the globe 12 to the DVD player 32. Alternatively, a switch provided on the surface of the globe in proximity with that particular spot the device 62 stops would be engaged. Based upon this location, the monitor 20 would provide the appropriate still photo or video clip, which could be in three dimensional. If indeed a three dimensional scene is projected, the individual would utilize a pair of 3-D glasses to view the scene. Similar to the embodiment illustrated with respect to FIGS. 1 and 2, a speaker 28 would provide the appropriate dialogue or music associated with a particular scene shown on the display 20.

Alternatively, instead of a plurality of tracks 60 used to move the plane or helicopter over the surface of the globe 12, the plane or helicopter could be magnetized and would be steered over the globe via the joystick or wheel 16 using magnetics. Additionally, similar to the embodiment shown in FIG. 2, the embodiment illustrated with respect to FIG. 4 includes a plurality of switches 42 which would be engaged by the send button 48 in combination with respect to the exact placement of the plane or helicopter in the track 60 or navigated using magnetics. Additionally, each of the locations associated with the switches 42 would have its own particular light emitting diode 40.

The steering mechanism, in this embodiment, would separately control the movement of the icon 27 on the monitor 20 or the movement of the device 62 over the globe. Additionally, steering mechanism could also simultaneously control the movement of the icon 27 as well as the device 62.

FIG. 5 shows a rudimentary scheme used to operate the present invention. The depression of a particular switch 42 would cause an oscillator 60, 62, 64 to produce a particular frequency 66, 68 or 70 which is transmitted from transmitter 18 to the receiver 22 to determine the particular spot on the globe that has been depressed, thereby enabling the DVD player to project the appropriate still photo or video clip, along with any and all audio information. A signal generated by the DVD player 32 in the first embodiment, wherein the joystick or wheel 16 indicates a location on the monitor 20 to be of interest, the appropriate LED 40 would be energized regardless of whether any of the switches 42 were depressed. As can be appreciated, each of the LEDs 40 would be sensitive to a particular signal generated by the DVD player. Finally, both the LEDs 40 and the switches 42 would be connected to a source of power, such as a battery 50 provided within the electronic globe 12, the support 14 or the game console itself.

The invention may be embodied in other specific forms without departing from the spirit or essential characteristics thereof. The present embodiments are therefore to be considered in all respects as illustrative and not restrictive, the scope of the invention being indicated by the appended claims, rather than by the foregoing description. Therefore, all changes which come within the meaning and range of equivalency of the claims are therefore intended to be embraced therein.

What is claimed is:

1. An instructional system used in conjunction with a display device for displaying material on a monitor included in a memory device inserted into the display device, comprising:
a three dimensional globe provided with geographical features on the surface of said globe, said globe provided with a plurality of switches, each of said switches in proximity with one of said geographical features and a plurality of illumination devices, each illumination device associated with one of said geographical features and one of said switches; and
a device for wirelessly communicating information between said globe and said display device, said information allowing particular material stored in the memory device to be displayed upon the monitor based upon a user choosing one of said geographic features.

2. The instructional system in accordance with claim 1, wherein said switches are provided on the surface of said globe, further wherein said switches are pressure responsive, and the selection of each of said switches produces a unique frequency transmitted to the display device for displaying information on the monitor related to the geographic feature associated with said selected switch.

3. The instructional system in accordance with claim 2, wherein the illumination device associated with a selected switch would be illuminated.

4. The instructional system in accordance with claim 1, further including a steering mechanism provided on a console for controlling the movement of an icon on the monitor.

5. The instructional system in accordance with claim 1, wherein said steering mechanism is attached to said globe.

6. The instructional system in accordance with claim 5, wherein said steering mechanism is attached to the base of said globe.

7. The instruction system in accordance with claim 6, wherein said steering mechanism is removably attached to said base of said globe.

8. The instructional system in accordance with claim 1, wherein said steering mechanism is a joystick.

9. The instructional system in accordance with claim 1, when said steering mechanism is a wheel.

10. The instructional system in accordance with claim 4, wherein said steering mechanism provides a wireless signal transmitted to said display device.

11. The instructional system in accordance with claim 4, wherein said console is provided with control buttons producing wireless signals transmitted to said globe and/or the display device.

12. The instructional system in accordance with claim 1, further including a steering mechanism provided on a console for controlling the movement of a movable device on the surface of said globe.

13. The instructional system in accordance with claim 12, wherein the surface of said globe is provided with tracks over which said movable device moves by operation of said steering mechanism.

14. The instructional system in accordance with claim 12, wherein said movable device is magnetic.

15. The instructional system in accordance with claim 12, wherein said steering mechanism is a joystick.

16. The instructional system in accordance with claim 12, wherein said steering mechanism is a wheel.

17. The instructional system in accordance with claim 4, wherein said icon includes a propeller which spins as said icon moves across said monitor.

18. The instructional system in accordance with claim 12, wherein said moveable device is provided with a propeller which spins as said moveable device moves across the surface of said globe.

19. The instructional system in accordance with claim 13, wherein said steering mechanism additionally controls the movement of an icon on said monitor.

20. The instructional system in accordance with claim 19, further including means for said steering mechanism simultaneously controlling the movement of said moveable device on said tracks and said icon on said monitor.
